(19) United States
(12) Patent Application Publication
(10) Pub. No.: US 2025/0231341 A1
(43) Pub. Date: Jul. 17, 2025

(54) INTEGRATED OPTICAL WAVEGUIDES, DIRECT-BONDED WAVEGUIDE INTERFACE JOINTS, OPTICAL ROUTING AND INTERCONNECTS

(71) Applicant: ADEIA SEMICONDUCTOR BONDING TECHNOLOGIES INC., San Jose, CA (US)

(72) Inventors: Shaowu HUANG, Sunnyvale, CA (US); Javier A. DELACRUZ, San Jose, CA (US); Liang WANG, Newark, CA (US); Guilian GAO, San Jose, CA (US)

(21) Appl. No.: 19/170,954

(22) Filed: Apr. 4, 2025

Related U.S. Application Data
(63) Continuation of application No. 18/508,556, filed on Nov. 14, 2023, now Pat. No. 12,271,032.
Application No. 18/508,556 is a continuation of application No. 17/507,019, filed on Oct. 21, 2021, now Pat. No. 11,860,415.
Application No. 17/507,019 is a division of application No. 16/247,262, filed on Jan. 14, 2019, now Pat. No. 11,169,326.
(60) Provisional application No. 62/635,314, filed on Feb. 26, 2018.

(51) Int. Cl. G02B 6/13; G02B 6/12

(52) U.S. Cl. CPC G02B 6/13; G02B 2006/12061; G02B 2006/12097

(57) ABSTRACT

Integrated optical waveguides, direct-bonded waveguide interface joints, optical routing and interconnects are provided. An example optical interconnect joins first and second optical conduits. A first direct oxide bond at room temperature joins outer claddings of the two optical conduits and a second direct bond joins the inner light-transmitting cores of the two conduits at an annealing temperature. The two low-temperature bonds allow photonics to coexist in an integrated circuit or microelectronics package without conventional high-temperatures detrimental to microelectronics. Direct-bonded square, rectangular, polygonal, and noncircular optical interfaces provide better matching with rectangular waveguides and better performance. Direct oxide-bonding processes can be applied to create running waveguides, photonic wires, and optical routing in an integrated circuit package or in chip-to-chip optical communications without need for conventional optical couplers. An example wafer-level process fabricates running waveguides, optical routing, and direct-bonded optical interconnects for silicon photonics and optoelectronics packages when two wafers are joined.

### RELATED APPLICATIONS

The patent application is a continuation of U.S. patent application Ser. No. 18/508,556 to Huang et al., filed Nov. 14, 2023, titled “Integrated optical waveguides, direct-bonded waveguide Interface joints, optical routing and Interconnects,” which is a continuation of U.S. patent application Ser. No. 17/507,019 to Huang et al., filed Oct. 21, 2021, now U.S. Pat. No. 11,860,415, issued Jan. 2, 2024, titled, “Integrated optical waveguides, direct-bonded waveguide Interface joints, optical routing and Interconnects,” which claims the benefit of priority to U.S. patent application Ser. No. 16/247,262 to Huang et al., filed Jan. 14, 2019, now U.S. Pat. No. 11,169,326, issued Nov. 9, 2021, titled, “Integrated optical waveguides, direct-bonded waveguide Interface joints, optical routing and Interconnects,” which claims the benefit of priority to U.S. Provisional Patent Application No. 62/635,314 to Huang et al., filed Feb. 26, 2018, titled, “Integrated optical waveguides, direct-bonded waveguide Interface joints, optical routing and Interconnects,” the entire contents of each of which are hereby incorporated herein by reference.

### BACKGROUND

In the past, conventional fabrication of silicon and silicon dioxide (silica) optical waveguides traditionally relied on high temperatures that exceeded 1000° C. Such high temperatures damaged or weakened microelectronic devices. Conventional waveguides based on silicon and silicon dioxide also required a light-bending radius that was too large to include such optoelectronic circuits on small electronic dies and chips. Ongoing efforts aim to fully integrate silicon photonics with conventional microelectronics in unified packages, where optical interconnects provide faster data transfer between dies and microchips, and also faster data transfer within the dies and chips themselves.

Silicon, as a good conductor of infrared light, has become important to optoelectronics and provides many technical and economic advantages. Silicon photonics can combine the advantages of photonics with the widespread use of silicon in conventional CMOS manufacturing. Photonics offers high-performance communication, low power of operation, and small size and weight. CMOS offers volume production, low cost, miniaturization, and high integration. Silicon photonics therefore provides high integration, miniaturization, higher bandwidth, lower cost, and lower power of operation. Micro-optoelectronic integration using silicon photonics also cuts the cost of optical links.

Compound semiconductors for optoelectronics and silicon photonics combine an element from group III of the periodic table (e.g., In, Ga, Al) with an element from group V of the periodic table (e.g., As, P, Sb, N). This yields twelve different III-V compounds, but the most commercially useful of these are currently GaAs, InP, GaN, and GaP. On a silicon substrate it is very difficult to epitaxially grow quality III-V semiconductor materials needed for mass-produced construction of photonic devices. Fabrication procedures such as etching are completely different from silicon processes. Moreover, contamination from III-V semiconductors must be completely prevented from contact or inclusion with the silicon of silicon electronics. Thus, it is difficult to introduce III-V semiconductor compounds into silicon electronics. Polymer waveguides of organic compounds cause less damage to electronic devices, but they are limited to the uppermost layers available only after electronic circuits have been completed, or to other locations isolated from the electronic devices being fabricated because they cannot withstand the high temperatures present in electronic device fabrication.

Silicon photonic circuits most often operate in the infrared at a wavelength of 1550 nanometers, at which silicon becomes a good conduit for transmission of the infrared optical beams. A top and bottom cladding of silicon dioxide (silica) on a waveguide structure made of silicon confines the infrared light within the silicon due to differences in the refraction indices of silicon and silicon dioxide, similar in some respects to how light is conducted in a fiber optic filament. Silicon photonic devices that use such silicon waveguides can be constructed by semiconductor fabrication techniques previously used exclusively for microelectronics. Since silicon is already used as the substrate in most conventional integrated circuits for microelectronics, hybrid devices in which the optical and electronic components are integrated onto a single microchip can be made with conventional semiconductor fabrication processes, sometimes even without retooling.

Processes that fabricate photonic devices using silicon and silicon dioxide can also utilize conventional silicon on insulator (SOI) techniques that are already well-known in microelectronics, providing a SOI waveguide layer on a wafer, to which optical dies such as LEDs, lasers, and photodetectors may be conventionally attached by less-than-ideal means.

### SUMMARY

Integrated optical waveguides, direct-bonded waveguide interface joints, optical routing and interconnects are provided. An example optical interconnect joins first and second optical conduits. A first direct oxide bond at room temperature joins outer claddings of the two optical conduits and a second direct bond joins the inner light-transmitting cores of the two conduits at an annealing temperature. The two low-temperature bonds allow photonics to coexist in an integrated circuit or microelectronics package without conventional high-temperature photonics processes destroying the microelectronics. Direct-bonded square, rectangular, polygonal, and noncircular optical interfaces provide better matching with rectangular waveguides and better performance. Direct oxide-bonding processes can be applied to create running waveguides, photonic wires, and optical routing in an integrated circuit package or in chip-to-chip optical communications without need for conventional optical couplers. An example wafer-level process fabricates running waveguides, optical routing, and direct-bonded optical interconnects for a silicon photonics-microelectronics package when two wafers are joined.

This summary is not intended to identify key or essential features of the claimed subject matter, nor is it intended to be used as an aid in limiting the scope of the claimed subject matter.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein.

FIG. 1 is a diagram of an example optoelectronics package with components coupled by an optically-enabled interposer with direct-bonded waveguide interface joints.

FIG. 2 is a diagram of an example optical interface between example optical conduits.

FIG. 3 is a diagram of an example optical interface with noncircular cross-section, between example optical conduits.

FIG. 4 is a diagram of example optical waveguides and optical traces with waveguide interface joints created by processes that include direct bonding at low-temperatures.

FIG. 5 is a diagram of an example substrate, such as a silicon on insulator (SOI) substrate, with photonic waveguides as optical traces attached to the substrate via direct bonding techniques.

FIG. 6 is a diagram of an example integrated optical waveguide fabricated by a wafer-level process.

FIG. 7 is a diagram of example mode profiles of a silicon ribbed waveguide with dimensions suitable for optical routing and chip-to-chip communications via integrated optical waveguides and direct-bonded waveguide interface joints.

FIG. 8 is a flow diagram of an example method of making an integrated optical waveguide in a wafer-level process

### DESCRIPTION

### Overview

This disclosure describes integrated optical waveguides, direct-bonded waveguide interface joints, optical routing and interconnects. Example processes and apparatuses described herein provide various ways of using direct bonding techniques to create integrated optical waveguides, direct-bonded waveguide interface joints, photonic wire, and chip-to-chip optical routing. Optical transmission and routing terms and phrases, such as “optical conduit,” “optical trace,” “waveguide,” “photonic wire,” “optical circuit,” and component parts of these, may be used somewhat interchangeably herein, depending on context.

An example optical interconnect joins first and second optical conduits. A first direct oxide bond performed at room temperature joins outer claddings of the two optical conduits, and a second direct bond joins the inner light-transmitting cores of the two conduits at an annealing temperature, for example. The second direct bonding of the inner cores is formed during an annealing process due to the differential in coefficients of thermal expansion between the outer cladding and the inner core of each optical conduit being joined. These two low-temperature bonds allow photonics processes to be applied in a single integrated circuit or microelectronics package without conventional high-temperature photonics processes destroying the microelectronics. Direct-bonded square, rectangular, polygonal, and noncircular optical interfaces with no gaps or minimal gaps in the interface between surfaces, and no detrimental extra layers added to make the interface, provide better matching with rectangular waveguides and provide better performance. Direct oxide-bonding processes can be applied to create running waveguides, photonic wires, and optical routing in an integrated circuit package or in chip-to-chip optical communications without need for conventional optical couplers. An example wafer-level process fabricates running waveguides, optical routing, and direct-bonded optical interconnects for a silicon photonics-microelectronics package when two wafers are joined.

The example integrated optical waveguides, direct-bonded waveguide interface joints, optical routing and interconnects described herein provide nano-small geometrical structures for compatibility with silicon electronics, so that very small optoelectronics packages may be produced.

The example integrated waveguides described herein can accommodate passive and dynamic photonic devices, wavelength filters, modulators, as well as compatibility with light emission functions, and light detection functions with low propagation loss.

The example optical waveguides used as photonic routing can have nano-small core dimensions and micrometer-scale bending sections to match the scale of microelectronic circuits. The example waveguides can be constructed on silicon-on-insulator (SOI) substrates, where the uppermost silicon layer of the SOI substrate is employed as the waveguide core, eliminating the need to specially form the core material. The cladding material can be silica-based compounds like silicon dioxide, formed by low-temperature processes, plasma-enhanced chemical vapor deposition, and so forth. Bonding between materials at the example optical interfaces can be performed by low-temperature DBI or ZIBOND direct bonding processes (Xperi Corporation, San Jose, CA). These features result in optoelectronic packages that have low power consumption and low packaging cost.

### Example Systems

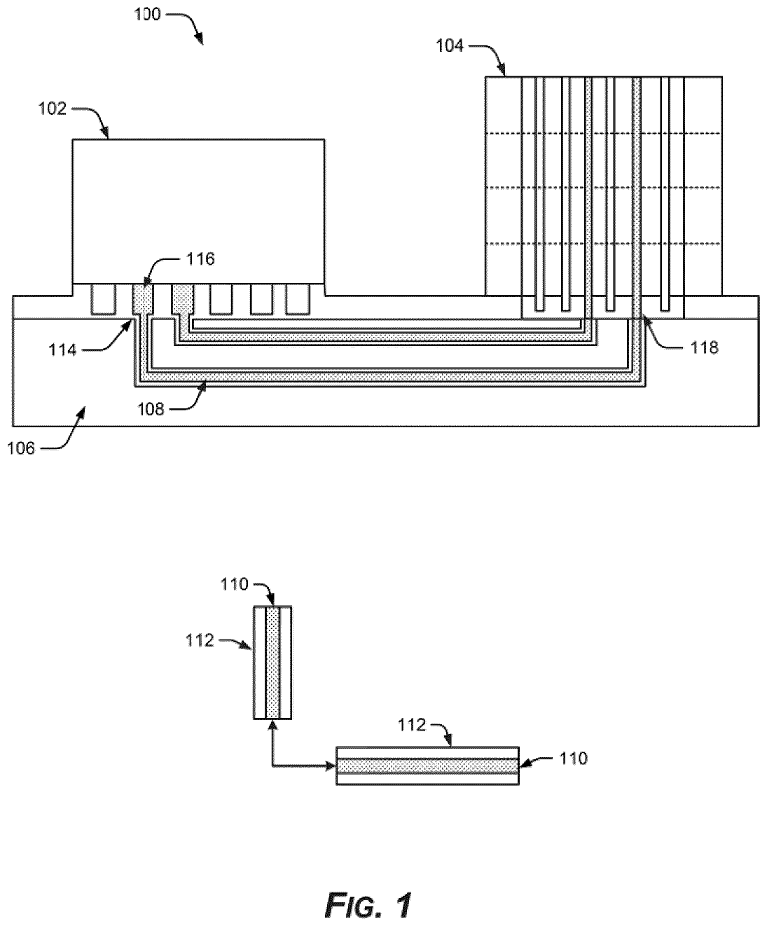

FIG. 1 shows an example optoelectronics package 100, with an optoelectronic computing chip 102 optically coupled with an optoelectronic memory stack 104 through an optically-enabled interposer 106. The interposer 106 may be a substrate or part of a substrate, or may be an optoelectronic chip in its own right.

The interposer 106 has one or more optical conduits 108 built into the interposer 106. In an implementation, the optical conduits 108 may include a waveguide or a photonic wire. In a silicon photonics implementation, a ribbed and/or rectangular waveguide version of the optical conduits 108 may transmit or guide (“conduct”) infrared light as optical communications power.

The optical conduits 108 each generally include an inner core 110 surrounded by an outer cladding 112. The inner core 110 transmits optical power in one of several possible modes, while the outer cladding 112 confines the infrared light within the silicon inner core 110 due to differences in the refraction indices of silicon and silicon dioxide. In a rectangular waveguide implementation of the optical conduits 108, top and bottom claddings 112 of silicon dioxide on a silicon waveguide structure of rectangular cross-section confine the infrared light within the silicon. In a ribbed implementation of the silicon waveguide optical conduits 108, a rectangular rib on one side of the rectangular waveguide structure guides, directs, and/or bends the optical power wavefront. Example optical interfaces 114 optically join device optical conduits 116 & 118 of the optoelectronic computing chip 102 and of the optoelectronic memory stack 104 with the optical conduits 108 of the interposer 106, in this example.

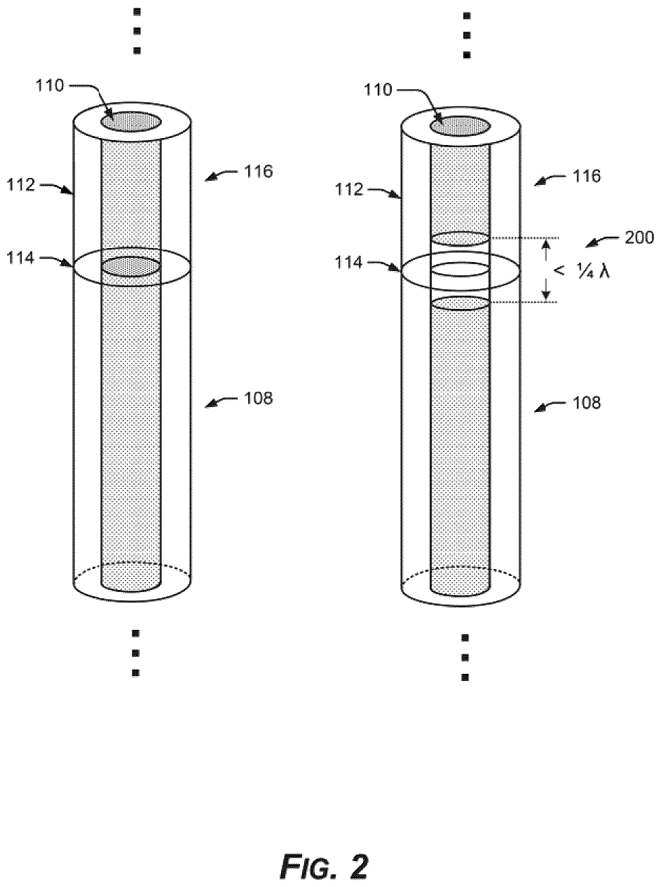

FIG. 2 shows an example optical interface 114 between example optical conduit 116 and optical conduit 108. The optical interface 114 may also include electrical contacts bonded to each other with low-temperature direct bonds (not shown). The example optical interface 114 provides a direct bonding waveguide interface joint. A first example technique applies direct oxide bonding to create the optical interface 114 between a first optical component, such as the photonics of the optoelectronic computing chip 102 and a second optical component, such as an optical waveguide version of the optical conduits 108 of the interposer 106. The example technique for making optical interfaces can be used in the construction of 3D and 2.5D photonic integrated circuits, for example.

In the example process for creating an optical interface 114, an inner core 110 of the optical conduits 116 & 108 may be made of a first material that conducts light at one or more wavelengths. The inner light-transmitting material may be silicon (Si), or other optical materials such as ZrO₂, HfO₂, TiO₂, LiNbO₃, Nb₂O₅, SrTiO₃, or ZnS, for example. The outer cladding 112 of the optical conduits 116 & 108 has a lower refractive index than the material that makes up the inner core 110 of the optical conduits 116 & 108, so that the inner core 110 transmits the light and the outer cladding 112 reflects or refracts light that is leaving the inner core 110 back into the inner core 110. The outer cladding material may be silicon dioxide (SiO₂) in the case of a silicon inner core 110, for example, or may be a polymer, such as polyimide, parylene, or other material with a suitable refractive index with respect to the material of the inner core 110 of the optical conduits 116 & 108.

In an implementation, through a direct bonding process, such as a direct oxide bonding process or an oxide-to-oxide direct bonding process, the outer cladding 112 is joined to a counterpart of the same material on the other side of the interface 114. In an implementation, the example direct oxide-bonding process takes place at room temperature, with minimal or no gaps, between surfaces being joined, and no detrimental extra layers created or introduced into the optical interface 114 during the process.

Depending on materials and process, there may be an allowable gap 200 or multiple partial gaps between the inner cores 110, at the surfaces being joined, or there may be no gaps. A permissible gap 200 has a gap size (vertical gap) less than one-quarter of the wavelength of the operational optical signal being conducted as electromagnetic waves. The gap 200 is shown as exaggerated in FIG. 2, for purposes of illustration. For silicon photonics, using silicon as the inner core 110 of a conduit 108, the signal is often conducted by infrared light at a wavelength of approximately 1550 nanometers, or in the range of approximately 1100-1550 nanometers. So in some circumstances, a gap 200 of less than approximately 387.5 nanometers is permissible in the interface between conduits 108 & 116, either as part of a fabrication process or a defects. The inner cores 110 of the optical conduits 116 & 108, within the respective outer claddings 112, are also direct-bonded in a second step to their counterparts of inner core material on the other side of the interface 114, during an annealing step or separate annealing process, for example. The annealing process may have an annealing temperature that is at least slightly higher than room temperature, but is still a very low-temperature when compared with conventional fabrication temperatures for conventional optical waveguides. The direct-bonding of the inner cores 110 to each other to complete the optical interface 114 also introduces minimal or no gaps and no detrimental extra layers of material into the interface 114 being formed, during the process.

The first direct oxide bond and the second direct bond join the first optical conduit 116 and the second optical conduit 108 together in a layerless join or a join with no detrimental intervening layers between the first optical conduit 116 and the second optical conduit 108. Likewise, the first direct oxide bond and the second direct bond join the first optical conduit 116 and the second optical conduit 108 together in a join with no gap or permissible gap between the first optical conduit 116 and the second optical conduit 108.

The optical interface 114 may also include electrical contacts associated with each of the first optical conduit 116 and the second optical conduit 108, wherein a first set of electrical contacts of the first optical conduit 116 are direct oxide bonded or direct bonded to a second set of electrical contacts of the second optical conduit at the optical interface 114.

In an implementation, an example apparatus includes a first optical conduit 116 on a first side of an optical interface 114 of a photonic device, a second optical conduit 108 on a second side of the optical interface 114 of the photonic device, and a first direct oxide bond between outer claddings 112 of the first optical conduit 116 and the second optical conduit 108. There is a second direct bond between inner cores 110 of the first optical conduit 116 and the second optical conduit 108. The apparatus may further include a first optical component 102 on the first side of the optical interface 114, the first optical component 102 having at least a first planar surface exposing a cross-section of the first optical conduit 116, and a second optical component 104 on the second side of the optical interface 114. The second optical component 104 also has at least a second planar surface exposing a cross-section of the second optical conduit 108, which may be an optical waveguide. The second optical conduit 108 also has an inner core 110 and an outer cladding 112 around the inner core 110.

The first direct oxide bond between the outer claddings 112 of the two optical conduits 116 & 108 can be an oxide bond formed at room temperature, such as a

ZIBOND brand of direct oxide-to-oxide bonding (Xperi Corporation, San Jose, CA). The second direct bond of the inner cores 110 can be a metal-to-metal, semiconductor-to-semiconductor, or photonic-material-to-photonic-material bond formed at an annealing temperature used for strengthening, curing or setting the previous direct oxide bond for the outer claddings 112. For example, two surfaces of silicon may form crystal lattice bonds at the optical interface with each other. ZIBOND bonding is a low-temperature wafer-to-wafer or die-to-wafer bonding technique between wafers or dies with the same or different coefficients of thermal expansion (CTE), using a low-temperature homogeneous (oxide-to-oxide) direct bonding technology. ZIBOND bonding offers multiple benefits over conventional bonding techniques such as adhesives, anodic bonding, eutectic bonding and glass frit. Bonding is performed at room temperature, which enhances overall yield and reliability, by eliminating the negative effects associated with coefficient of expansion (CTE) mismatch, warpage and distortion. Higher throughput and lower cost-of-ownership are realized by using industry-standard wafer alignment and bonding equipment. Without requiring elevated temperature or high pressure during bonding, the high-throughput of the ZIBOND bonding fabrication process minimizes cost-of-manufacturing during mass-production for high volume market applications. During ZIBOND processing, industry standard dielectric surfaces like silicon dioxide or silicon carbide nitride are polished to low surface roughness using conventional chemical-mechanical polishing (CMP) tools, and nitrogen-based chemistries are applied through conventional plasma etch processing. Prepared wafer surfaces are then simply aligned and placed together, resulting in the spontaneous formation of chemical bonds between die and/or wafers. A very strong, low distortion chemical bond with a bond strength about half the strength of silicon can be obtained at room temperature, and a reliable hermetic bond stronger than silicon can be obtained after moderate heating to about 150° C. in batch processes outside of the alignment and placement tool, for example.

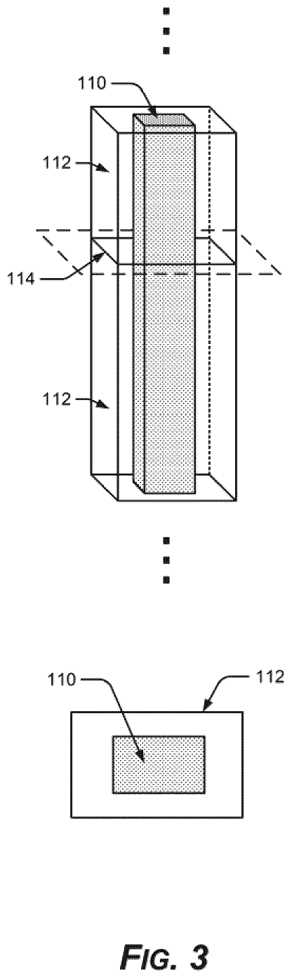

FIG. 3 shows an example optical interface 114 between the first optical conduit 116 and the second optical conduit 108, with a noncircular cross-section 402 in a plane of the optical interface 114. The optical interface 114 may also include electrical contacts bonded to each other with low-temperature direct bonds (not shown). The example optical interface 114 provides a direct bonding waveguide interface joint. In an implementation, the optical interface 114 comprises a join having a noncircular cross-section between the first outer cladding 112 of the first optical conduit and the second outer cladding 112 of the second optical conduit in the plane of the optical interface. The optical interface 114 also has a noncircular join between the first inner core 110 of the first optical conduit and the second inner core 110 of the second optical conduit.

In one instance, the optical interface 114 may have a rectangular cross-section, a square cross-section, or a polygonal cross-section in a plane of the optical interface 114. In some cases, the first optical conduit 108 on one side of the optical interface 114 has a noncircular, rectangular, square, or polygonal cross-section and the other optical conduit 116 has a circular cross-section in the plane of the optical interface.

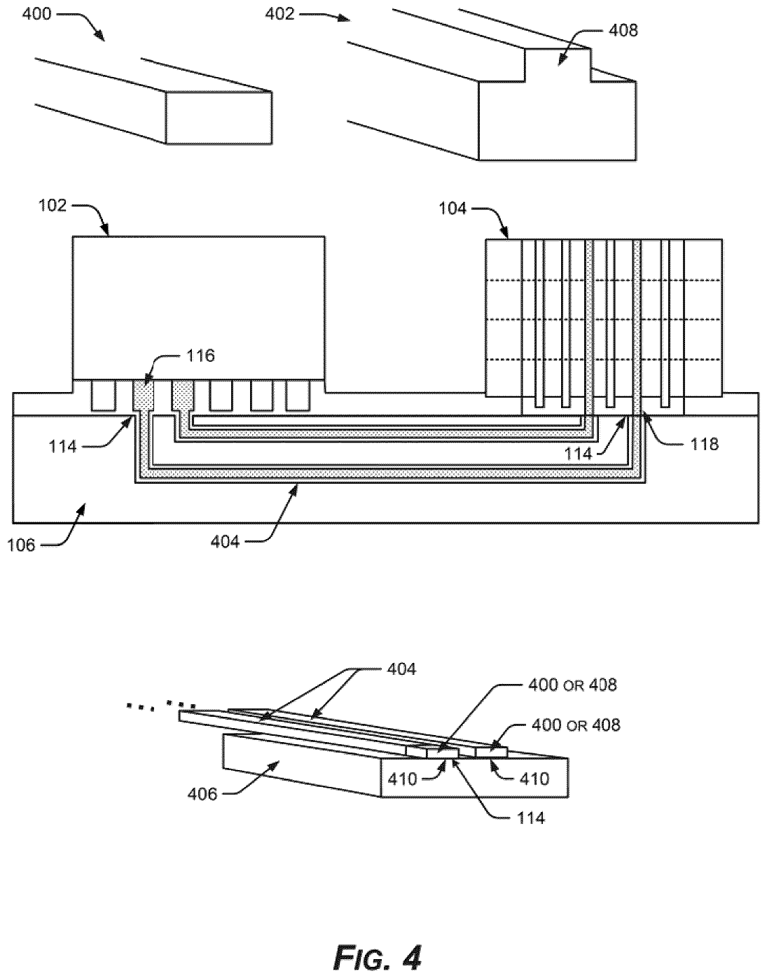

FIG. 4 shows example optical waveguides 400 created by processes that include direct bonding at low-temperatures. The optical waveguides 400, including ribbed waveguides 402, can be routed as optical traces 404 or photonic wires in microelectronic and optoelectronic circuit layouts. The low-temperature direct bonding technique can also be used to attach the optical waveguides 400 to chips 102 & 406 and to other components with example optical interfaces 114 in ways that can eliminate the need for optical couplers in chip-to-chip communications. The example optical interface 114 provides a direct bonding waveguide interface joint between the optical traces 404 and the optoelectronic microchip 406. The waveguides 400, fabricated using low-temperature bonding techniques, can be formed as optical traces 404 along the surface layers of chips 406, and between chips, to provide optical routing similar to the routing of electrical conductors, at reduced size over conventional optical channels.

An example optoelectronic apparatus includes an optical trace 404 bonded to a die or a chip 406 made at least in part of a semiconductor material, and a direct oxide bond between the optical trace 404 and the die or chip 406. The direct oxide bond may be an oxide-to-oxide bond formed at room temperature or at a temperature near or below room temperature. Material used for the waveguides 400 employed at optical traces 404 are optically transparent or photonic materials, including some semiconductors. The direct oxide bond itself can be optically transparent, or optically transparent at least in part.

In one layout, the optical trace 404 transmits a light or electromagnetic radiation between a first die or chip 102 and a second die, chip 104, or stack of dies. The optical trace 404 may be directly oxide-bonded to a first die or chip 102 and to a second die or chip 104. The optical trace 404 can provide an optical path between the first die or chip 102 and the second die 104 or chip without conventional inline optical couplers.

In an implementation, on a given die or microchip 406, the optical trace 404 may be a rib member 408 of an optical waveguide. The rib member 408 is direct bonded 410 to a semiconductor material of the die or microchip 406 to make the optical waveguide 402 serving as an optical trace 404, wherein the optical waveguide 402 comprises the rib member 408, the direct bond 410, and the semiconductor material of the die or the microchip 406.

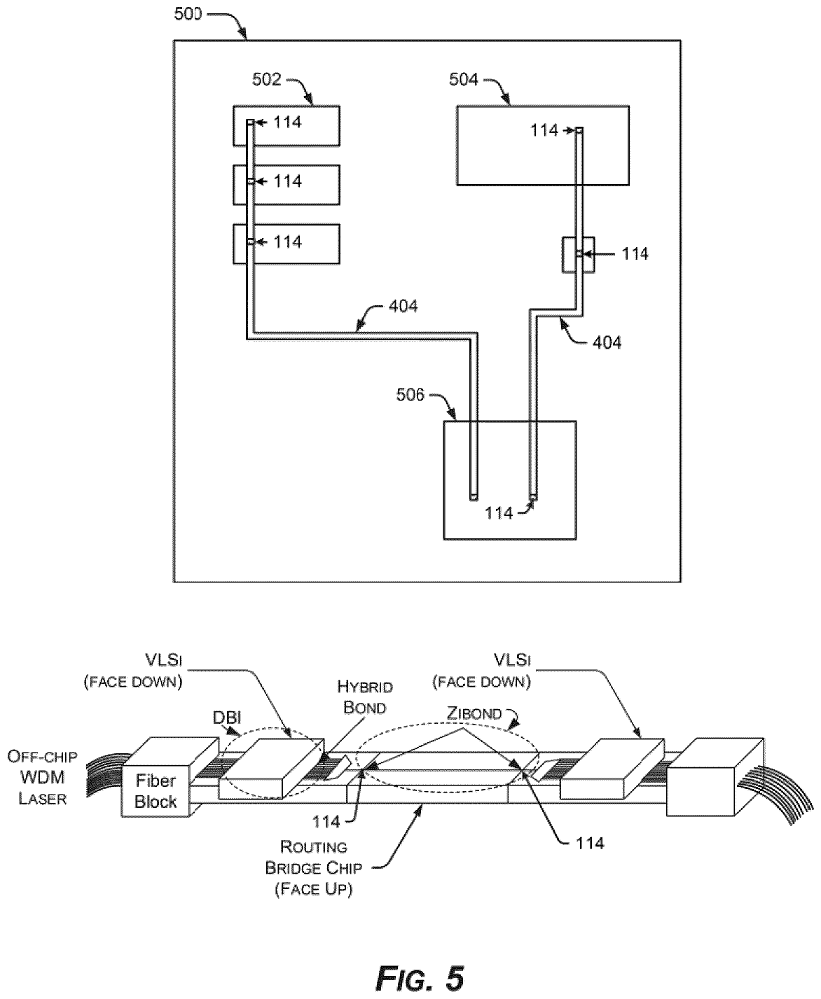

FIG. 5 shows a substrate, such as a silicon on insulator (SOI) substrate 500, with photonic waveguides as optical traces 404 attached to the substrate 500 via direct bonding techniques. The optical traces 404 are routed on the substrate 500 to and between microchips 502 & 504 & 506. The optical traces 404 may be rectangular waveguides 400 or ribbed waveguides 402. In an implementation, only the rib member 408 is direct-bonded to a semiconductor material of the substrate 500, such as a silicon on insulator (SOI) substrate 500, to create waveguides 400 & 402 for routing optical paths. The tops of waveguides 400 and 402 may be clad with an oxide 112 of suitable refractive index, such as silicon dioxide, to complete the waveguide structures. The waveguides 400 & 402 may also be attached as a layer of semiconductor, for example, to an SOI wafer or substrate, and then etched into waveguide structures 400 & 402 and topped with silicon dioxide or other material with suitable index of refraction to make optical waveguide structures 400 and 402. The optical traces 404 as completed waveguides can provide a continuous optical trace 404, an optical bus, and an unbroken optical pathway between the multiple dies or microchips 502 & 504 & 506 across the substrate 500, using low-temperature direct bonding techniques.

The low-temperature direct bonding techniques are used to attach the optical traces 404 to chips 502 & 504 & 506 and to other optoelectronic components with example optical interfaces 114 that eliminate the need for optical couplers in chip-to-chip communications. The example optical interfaces 114 provides direct bonding waveguide interface joints between the optical traces 404 and optoelectronic microchips 502 & 504 & 506.

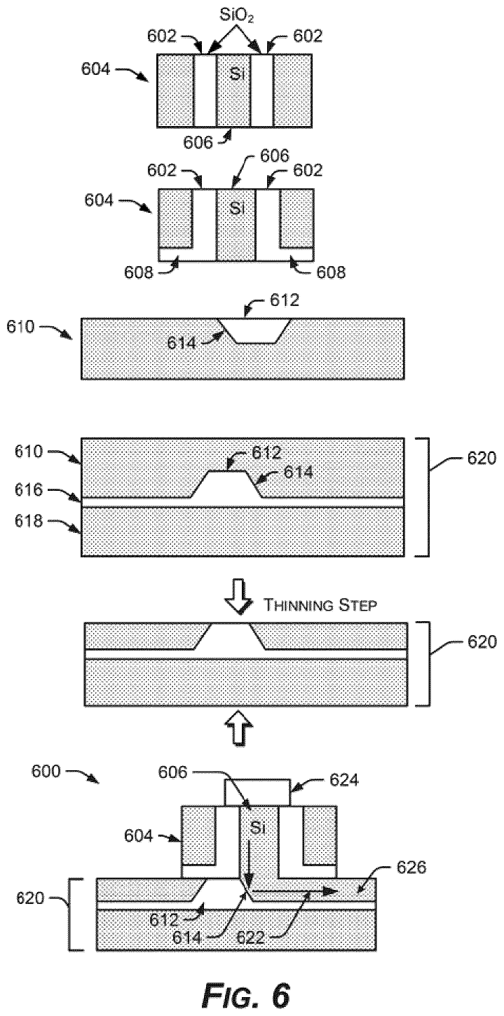

FIG. 6 shows an example photonic or optoelectronic apparatus, such as an integrated optical waveguide 600, fabricated by wafer-level fabrication. The wafers for making the optoelectronic apparatus may have dies for optoelectronics or microelectronics, and may also have optical devices with III-V semiconductor optical compounds, mounted to one or more of the wafers.

To make the example apparatus or integrated optical waveguide 600, an example process includes coupling optical components and electrical contacts together across an optical interface at a single bonding surface between the wafers, while simultaneously fabricating photonic waveguides for optical routing in the optoelectronic package or structure being formed. The use of low-temperature direct oxide bonds in this example process allows unification or convergence of silicon photonics and microelectronics together in the same wafer-produced package. Some aspects of the example process can also be used to form waveguides in die-to-die processes or to perform vertical direct optical coupling and electrical coupling of contacts from one die to another with minimal or no gaps and no detrimental extra layers, and without requiring underfill or bumps.

In one implementation, a channel 602 is etched in a first wafer 604 of silicon to make a silicon pillar 606 surrounded by the channel 602 in the first wafer 604. The channel 602 may be filled with a dielectric that has a suitable refractive index relative to the silicon to create an optical conduit and part of a waveguide.

A recess 608 is formed in the first wafer 604 of silicon in an area around the channel 602 and silicon pillar 606. A first oxide material is deposited in the recess 608 for later purposes of direct oxide-bonding between wafers, at low-temperature.

On a second wafer 610 made of silicon, a trench 612 is etched, having an angled side 614, such as at least one 45 degree side in the trench 612. A second oxide is deposited in the trench 612. The oxide deposited in the trench 612 of the second wafer 610 may be the same oxide as deposited in the recess 608 of the first wafer 604.

The trench-side of the second wafer 610 is bonded to at least an oxide layer 616 of a third wafer 618 to make an interposer 620. The interposer 620 may be thinned at this point, as desired. The first wafer 604 is then bonded to the interposer 620 by direct oxide-to-oxide-bonding of the first oxide in the recess 608 of the first wafer 604 to at least the oxide in the trench 614 of the second wafer 610 to make the example integrated waveguide 600 of silicon, or other optical apparatuses bonded at a single waveguide interface plane with direct oxide bonding.

Prior to bonding the first wafer 604 to the interposer 620 to make the integrated waveguide 600, the silicon pillar 606 of the optical conduit of the first wafer 604 is aligned with the angled side 614 of the trench 612 of the interposer 620 in order to fabricate an optical pathway 622 that connects optical power between a component 624 mounted on the first wafer 604 and the integrated waveguide 600. In an implementation, the integrated waveguide 600 guides the optical power around a corner formed by the angled side 614 of the trench 612 of the interposer 620, that is, from a vertical silicon pillar 606, for example, to a horizontal layer 626 of the silicon.

In an implementation, aligning the silicon pillar 606 with a 45 degree side 614 of the trench 612 prior to the bonding makes an integrated waveguide 600 capable of guiding infrared light propagating vertically from the silicon pillar 606 through a 90 degree change in direction into the horizontally disposed silicon layer 626 in the interposer 620.

The example process may use direct oxide-to-oxide-bonding between the oxide in the recess 608 of the first wafer 604 and the oxide in the trench 612 of the second wafer 610 or interposer 620, with the bonding at room temperature, which favors microelectronics located in the same vicinity, as higher temperatures can be detrimental to the microelectronics. The low bonding temperature also allows optoelectronic components with III-V semiconductor compounds to be fully finished and mounted prior to the bonding. Conventionally, components with III-V semiconductor compounds need special handling because they cannot withstand conventional microelectronics bonding temperatures.

The silicon of the pillar 606 and the silicon in the top horizontal layer 626 of the interposer 620 are joined together at the same time as the oxide interface, with spontaneous crystal lattice bonding at an annealing temperature slightly higher than room temperature.

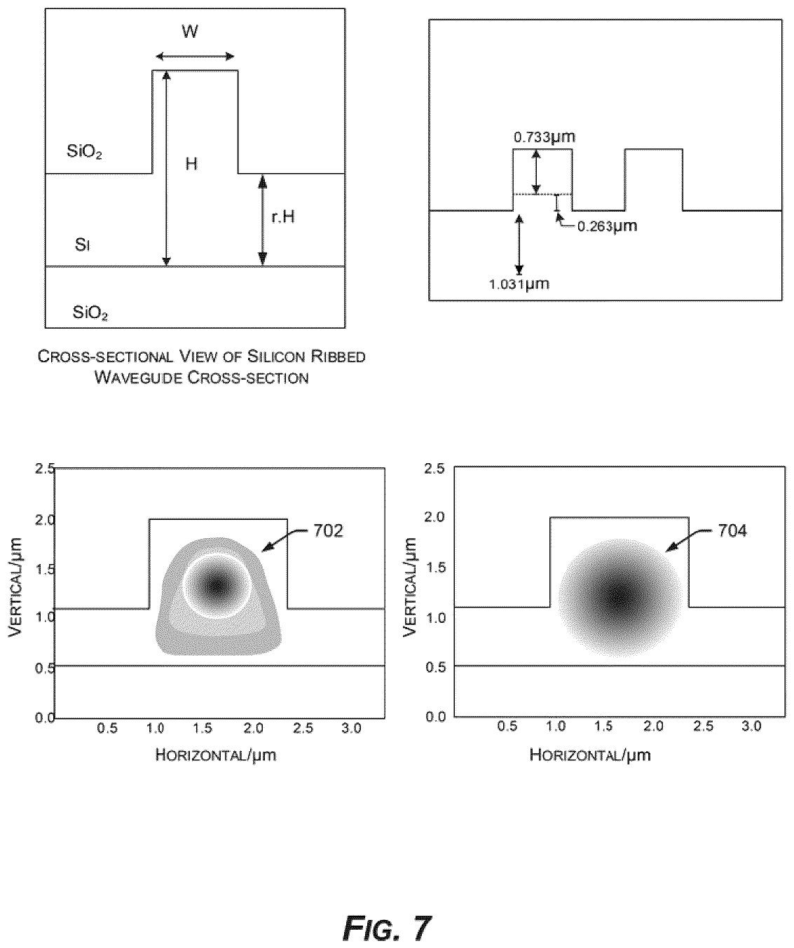

FIG. 7 shows diagrams of direct oxide-to-oxide bond-enabled silicon ribbed waveguides and example mode profiles. At dimensions of W=1.4 μm, H=1.5 μm, and r=0.39 at 1.55 μm, an example polarization-independent SOI ribbed waveguide has a fundamental transverse electric-like (TE-like) mode 702 (Ex field profile) with no electric field in the direction of propagation, and the example polarization-independent SOI ribbed waveguide has a fundamental transverse magnetic-like (TM-like) mode 704 (intensity profile) with no magnetic field in the direction of propagation.

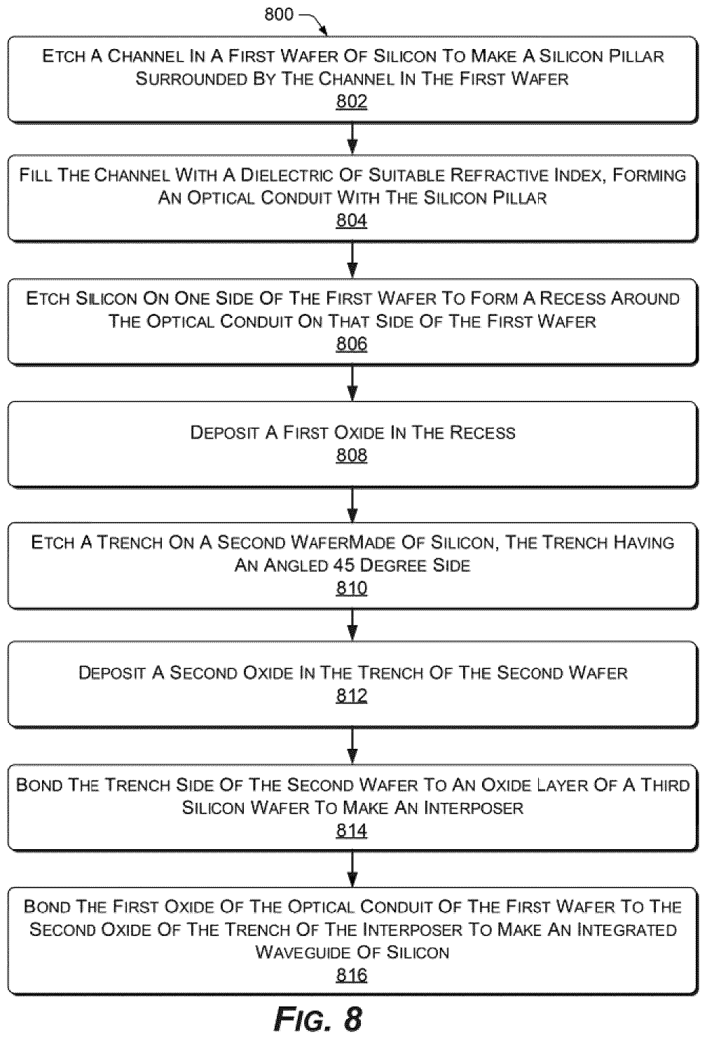

FIG. 8 shows an example method of making an integrated optical waveguide in a wafer-level process. Operations of the example method are shown in individual blocks.

At block 802, a channel is etched in a first wafer of silicon to make a silicon pillar surrounded by the channel in the first wafer. The method is not limited to silicon, but can be implemented in silicon as an example, to combine optical communications with microelectronics in a silicon photonics package.

At block 804, the channel may be filled with a dielectric or other material of suitable refractive index. The dielectric and the pillar being surrounded by the dielectric comprise an optical conduit for infrared light, in the case of silicon.

At block 806, the silicon on one side of the first wafer is etched or otherwise removed to form a recess around the optical conduit on that side of the first wafer.

At block 808, a first oxide is deposited in the recess.

At block 810, a trench is etched on a second wafer made of silicon, the trench having an angled side, such as at least one 45 degree side.

At block 812, a second oxide is deposited in the trench of the second wafer. The second oxide may be the same oxide compound as deposited in the recess of the first wafer, at block 808, or may be a different oxide.

At block 814, a trench side of the second wafer is bonded to an oxide layer of a third silicon wafer, such as a silicon on insulator (SOI) wafer, to make an interposer.

At block 816, the first wafer with the optical conduit is bonded to the interposer after alignment to make an integrated waveguide of silicon, including direct oxide-to-oxide-bonding of the first oxide in the recess of the first wafer to at least the second oxide in the trench of the second wafer.

In the specification and following claims: the terms “connect,” “connection,” “connected,” “in connection with,” and “connecting,” are used to mean “in direct connection with” or “in connection with via one or more elements.” The terms “couple,” “coupling,” “coupled,” “coupled together,” and “coupled with,” are used to mean “directly coupled together” or “coupled together via one or more elements.”

While the present disclosure has been disclosed with respect to a limited number of embodiments, those skilled in the art, having the benefit of this disclosure, will appreciate numerous modifications and variations possible given the description. It is intended that the appended claims cover such modifications and variations as fall within the true spirit and scope of the disclosure.

1. An optoelectronic apparatus, comprising:
a first die comprising a first bonding surface, the first bonding surface comprising a first set of electrical contacts and a first dielectric material;
a second die comprising a second bonding surface, the second bonding surface comprising a second dielectric material; and
an interposer comprising an optical trace, wherein the interposer comprises a third bonding surface comprising a set of interposer electrical contacts and a third dielectric material;
wherein the first set of electrical contacts is directly bonded to the set of interposer electrical contacts, and wherein the first dielectric is directly bonded to the third dielectric material.

2. The optoelectronic apparatus of claim 1, wherein the second bonding surface is directly bonded to the third bonding surface.

3. The optoelectronic apparatus of claim 1, wherein the first die comprises a first optical component and wherein the second die comprises a second optical component.

4. The optoelectronic apparatus of claim 1, wherein the optical trace comprises one of an optically transparent material, a photonic material, or a semiconductor material.

5. The optoelectronic apparatus of claim 1, wherein the optical trace provides an optical path between the first die and the second die in an absence of an optical coupler.

6. The optoelectronic apparatus of claim 1, further comprising a first dielectric direct bond between the first bonding surface and the third bonding surface, wherein the first dielectric direct bond comprises an oxide-to-oxide bond formed at room temperature or at a temperature near or below room temperature.

7. The optoelectronic apparatus of claim 1, wherein the optical trace comprises an optical waveguide.

8. The optoelectronic apparatus of claim 1, wherein the first die is made at least in part of a semiconductor material.

9. An optoelectronic apparatus, comprising:
a first optoelectronic die comprising a first bonding surface, the first bonding surface comprising first electrical contacts and a first dielectric material; and
an interposer comprising an optical trace and an interposer bonding surface, the interposer bonding surface comprising interposer electrical contacts and an interposer dielectric material, the optical trace to transmit an optical signal, wherein the interposer is in optical communication with the optoelectronic die,
wherein the first electrical contacts and the interposer electrical contacts are directly bonded, and wherein the first dielectric material and the interposer dielectric material are directly bonded.

10. The optoelectronic apparatus of claim 9, wherein the optical trace transmits the optical signal from an off-chip wavelength division multiplexing laser to the optoelectronic die.

11. The optoelectronic apparatus of claim 9, wherein the optical trace transmits the optical signal between an optical fiber and the optoelectronic die.

12. The optoelectronic apparatus of claim 9, wherein a source of the optical signal is off-chip.

13. The optoelectronic apparatus of claim 9, further comprising two or more optical traces to optically connect two or more optoelectronic dies, wherein the two or more optoelectronic dies includes at least the first optoelectronic die.

14. The optoelectronic apparatus of claim 13, wherein the interposer comprises a substrate and the optical trace, wherein the optical trace comprises a photonic waveguide attached to the substrate.

15. The optoelectronic apparatus of claim 9, further comprising a second optoelectronic die comprising a second bonding surface, wherein the second bonding surface is directly bonded to the interposer bonding surface.

16. The optoelectronic apparatus of claim 15, wherein the optical trace is configured to transmit the optical signal between the first optoelectronic die and the second optoelectronic die.

17. A method of forming an optoelectronic apparatus, the method comprising:
providing a first die comprising a first dielectric bonding surface, wherein the first die is made at least in part of a semiconductor material;
providing a second die comprising a second dielectric bonding surface;
providing an optical element comprising an optical trace and a third dielectric bonding surface;
directly bonding the first dielectric bonding surface to the third dielectric bonding surface to form a first dielectric direct bond; and
directly bonding the second dielectric bonding surface to the third dielectric bonding surface to form a second dielectric direct bond,
wherein the optical trace optically connects the first and second dies.

18. The method of claim 17, wherein the first dielectric direct bond comprises an oxide-to-oxide bond formed at room temperature or at a temperature near or below room temperature.

19. The method of claim 17, wherein the optical trace comprises one of an optically transparent material, a photonic material, or a semiconductor material, and the first dielectric direct bond is optically transparent, at least in part.

20. The method of claim 17, wherein the optical trace transmits a light or an electromagnetic radiation between the first die and the second die.

21. The method of claim 20, further comprising direct oxide bonding the optical trace to the first die and to the second die.

22. The method of claim 20, wherein the optical trace provides an optical path between the first die and the second die in an absence of an optical coupler.

23. The method of claim 17, wherein the optical trace is direct bonded to a substrate and to multiple dies, and wherein the optical trace provides a continuous waveguide, an optical bus, and an unbroken optical pathway between the multiple dies.

24. The method of claim 17, further comprising bonding the optical trace to the first die, wherein the first die comprises an optoelectronic chip comprising an optical conduit.

25. The method of claim 17, further comprising bonding a second optical trace to the first die.

26. The method of claim 17, wherein the optical element is an interposer.

27. The method of claim 17, further comprising bonding the first die to the optical trace at a first side of the optical element and bonding the second die to the optical trace at the first side of the optical element.

28. The method of claim 17, further comprising providing a first set of electrical contacts at a first side of the optical element and a second set of electrical contacts at a second side of the first die, and directly bonding the first set of electrical contacts with the second set of electrical contacts.
